(19) United States
(12) Patent Application Publication
(10) Pub. No.: US 2006/0155529 A1
(43) Pub. Date: Jul. 13, 2006

(54) System and method for a context-independent framework for management and execution of xml processing tasks

(75) Inventors: Georg Ludviksson, Reykjavik (IS); Gudmundur Hapsteinsson, Reykjavik (IS); Cunnlaugur Thor Briem, Reykjavik (IS)

Correspondence Address: BIRCH STEWART KOLASCH & BIRCH, PO BOX 747, FALLS CHURCH, VA, 22040-0747, US

(73) Assignee: Teamware Group OY, Helsinki (FI)

(21) Appl. No.: 10/524,766

(22) PCT Filed: Aug. 15, 2003
(86) PCT No.: PCT/IS03/00024

§ 371 Date: Aug. 31, 2005

(51) Int. Cl. G06F 17/28

(52) U.S. Cl. 704/4

(57) ABSTRACT

A system for a context-independent framework for management and execution of XML processing tasks is provided. The XML processing tasks are executed by a module, herein referred to as the XSA Engine, according to a predefined set of instructions provided as electronic documents written in a special purpose, XML-based, programming language. The instruction sets contain references to, and control the execution of, instances of three classes of processing modules, which independently accomplish an XML processing subtask and jointly accomplish an XML processing task. The framework is decoupled from any specific execution context, meaning that standardized XML processing can be applied in almost any desired application. The special purpose programming language enhances productivity for development of XML processing tasks as compared to using general purpose programming languages, and diminishes the need for writing custom code to link different types of XML processing subtasks to accomplish an XML processing task.

### FIELD OF THE INVENTION

A management system for execution of tasks involving context-independent processing of structured data using a special purpose programming language.

### BACKGROUND OF THE INVENTION

Most computer applications are designed to accomplish some task(s) and in the process ease life for its human users. Computer networks and the Internet have introduced new opportunities to ease life with computer applications. Today almost all computers within companies or organizations are connected to some computer network and commonly also to the Internet.

Recently, the Extensible mark-up language (XML), has emerged as a common method for describing any type of structured data. Extensive industry-support to XML and the ubiquity of XML development has caused increasing number of computer application vendors to offer some form of XML support in their applications. One type of XML support offered by some newer applications is called Web Services. A web service is a software component, which exposes a predefined XML interface to its data and services, generally accessible through the Internet.

XML is frequently used within the field of electronic publishing, especially if the publishing is performed on demand and involves moving data through a computer network. All browser applications, for example, understand some type of XML or XML-related data formats ( e.g. HTML, XHTML, WML) and render them for their human users. Other presentation formats for other types of electronic presentation may or may not be XML or XML-based but generally XML is well suited for publishing applications.

Electronic Business is another field where XML and the Internet play a major role. Electronic Business involves making, often automatic, electronic business transactions between organizations according to predefined rules and invocation criteria. EDI is a common, non-XML based, electronic business framework but all the currently emerging succession frameworks (e.g. BizTalk, ebXML, etc.) rely heavily on XML and the Internet.

In spite of the general adoption of computer networking many applications are not able to communicate freely with other applications on the network even though it might be beneficial to do so. Most applications have some capabilities to import or export data to or from external applications on a network. Unfortunately, however, most current applications generally require proprietary data formats and protocols making, possibly beneficial, communication between applications difficult. This means that, often highly desirable, automatic information exchange (integration) between applications generally requires, often custom-made, middleware (or interpreter software) to route data and translate between protocols and data formats before the applications can communicate freely and exchange data/information.

A related integration problem often arises when organizations want to access an integrated, unified interface to more than one back-end application. Since applications often do not communicate freely, no single application can offer an interface with a view on data from many systems. The only solution to this problem is to introduce portal software middleware, which needs to be able to communicate to all the required systems, merge and unify all the data as appropriate and then offer a consistent interface with an integrated view on the data/services from all the applications. Portal software, however, sometimes has the drawback of relying on duplicating data from many systems.

Another integration problem arises in electronic publishing. Many applications have limited presentation capabilities, frequently offering human interaction to its interface only in one type of media. This means that when new presentation needs arise, the introduction of, often custom made, middleware software is required to extend the interface of the application.

Another related presentation problem lies in the fact that many common electronic presentation formats (e.g. Adobe PDF documents, MS Word Documents) have little or no separation between content data and presentation data. This means that when new presentation needs might arise it is hard or impossible to adapt existing documents to new formats.

Some of the problems above can sometimes be remedied or even eliminated if organizations replace their old applications with newer ones. Many organizations, however, have tried to ameliorate the problems by introducing Enterprise Application Integration. This usually entails installing middleware, which can somehow extend the reach of existing applications, either by improving or extending an application's existing interface or by enabling the application to communicate with other applications.

XML is well suited for any application, which relies on structured data. Due to XML's unique properties and exceptionally wide industry support it has proven to be very useful in integration, electronic business and publishing applications. Many analysts believe that XML holds the promise to be able to really empower applications to talk to each other and therefore make life easier for their users. In practice this means lower cost of integration when XML is involved in the solution. It is at least clear that XML and XML related technologies are widely used in integration, electronic business and publishing software today and for a good reason.

Most specialists in the field believe it makes sense to utilize XML and XML-related technologies when developing certain types of applications, such as applications having to do with Integration of disparate systems, electronic business and publishing. Its usage within those applications, however, is often little standardized or ad hoc. The current situation may be described by saying that some organizations are using XML in a smart way to build better applications but some are not. Most of them are using it in an ad-hoc manner when existing XML-related specifications does not tell them what to do. The world of XML processing is full of small modules for narrowly defined tasks, but there is a lack of a well-defined framework for managing them together in a coherent way. This means that most current XML-based solutions rely to a certain degree on ad hoc programming “glue” to link together the different XML-based modules.

Thus, it is desirable to provide a method and a system for a framework for management and execution of XML processing tasks. Furthermore it is important that such a framework is decoupled from any specific execution context so to be flexible enough to be able to handle all cases where management framework for XML processing might be of value.

Furthermore, such a management framework should preferably rely on a special purpose programming language for defining the XML processing tasks in order to decrease or even eliminate the need for using general purpose programming languages to patch together many different XML processing tasks where each type of task is governed by an existing XML processing standard or specification. Having such a special purpose programming language for XML processing tasks would enable developers to be much more productive while defining XML processing tasks than Is possible with a general purpose programming language.

### SUMMARY OF THE INVENTION

Some of the problems associated with integration, publishing, electronic business or other fields where XML processing might be beneficial, are overcome or simplified by the preferred embodiments of the present invention. A method and a system for a framework for management and execution of XML processing tasks are provided. The framework is decoupled from any specific execution context meaning that the management framework can be applied anywhere within an application where XML processing is needed.

The invention relates to server-side XML applications, i.e. any server-side computer application where XML processing plays a major role or could play a major role. XML Applications are common in fields such as Enterprise Application Integration, Electronic Publishing and Electronic Business Transactions. More specifically, the invention relates to a method and a system for a standardized, structured, framework for management, definition and execution of XML processing tasks relying on a special purpose programming language for defining the processing tasks.

Furthermore, according to a preferred embodiment of the present invention, the XML management framework relies on a special purpose programming language, designed for the purpose of linking together different XML processing subtasks where each subtask is governed by a standard, method or specification well known in the art of XML processing. The special purpose programming language, being specifically designed for management of XML processing tasks, enables developers of XML processing tasks to be more productive than possible with general purpose programming languages, diminishing the need for writing custom code to link different types of XML processing subtasks to accomplish an XML processing task. Examples of useful applications are transformation and delivery of business messages, integration of disparate systems and web publishing.

One aspect of the invention includes a method and system for definition and execution of XML processing tasks according to a predefined set of instructions provided as electronic documents written in a special purpose programming language designed specifically for management and linking of XML processing subtasks, where each subtask is governed by a well known XML-related standard, specification or method. Each XML processing task defined by a specific instruction set in an electronic document written in a special purpose programming language will herein frequently be referred to as an XML Service Action or simply XSA. A software module capable of executing the XSA-s will herein be referred to as an XSA Engine. The format and syntax of the special purpose programming language, which defines how to create XML Service Action electronic documents, and is designed to manage XML processing tasks, may be accurately defined, preferably specifying the special purpose programming language's syntax to be XML based mark-up.

The method includes a system being invoked, by an external request, to execute a specific set of processing instructions, i.e. a specific XSA electronic document written in a special purpose programming language. The invocation includes an indication of which XSA to execute and may also include other information about the origin and purpose of the invocation. Upon being invoked the XSA engine locates the appropriate XSA electronic document and attempts to execute the instructions defined in it and, if appropriate, returns a response according to instructions found in the particular XSA being executed.

According to a preferred embodiment of the current invention, the XML management framework and the special purpose programming language are based on three different classes of XML processing modules, which jointly, and in conjunction with other parts of the present invention, accomplish the XML processing task as defined with a particular XSA. Each XSA, written according to the special purpose programming language, generally refers to, and controls the function of, at least one of each of those three classes of XML processing modules. XML Service Actions define, configure and control how these types of modules interact and together accomplish an XML processing task. The three module types are herein referred to as: Generators, Transformers and Sinks. Most XML processing subtasks, well-defined or well-known in the art of XML processing, can be classified to be a generating subtask, transforming/manipulating subtask or a sink subtask.

In any given XML processing task, as defined by any XSA, Generator modules are responsible for generating XML source data, Transformer modules are responsible for transforming or manipulating the XML source content to form a different kind of XML data (processed XML data) and finally Sink modules are responsible for interpreting, reacting to, or delivering the processed XML data. Generators generate XML source content, generally exposing data originating in an external system. An example of a Generator is a software module that communicates with an external system, e.g. a JDBC-compliant database, and exposes the content or services provided by the external system in XML format ready for further XML processing. Each Generator defines its own XML syntax in order to expose in a natural way the content or services offered by the back-end system(s), which it communicates to.

To further process, interpret or manipulate the XML source data, in order to perform the requested XML processing task defined in a specific XSA, one or more Transformers generally transform, interpret, validate, react to or somehow manipulate the XML content, generally resulting in a different kind of (or at least inspected or validated) XML data, herein referred to as processed XML data. Transformers are modules that have XML data as both input and output, and many Transformers can be applied in series. One example of a Transformer is a software module, which transforms XML according to a given stylesheet written in the Extensible Stylesheet Language Transformations (XSLT). Depending on its purpose, each type of Transformer may or may not impose restrictions on its XML input data received from Generators or other Transformers. Each Transformer also defines the form of the processed XML output data.

The final part of executing the XML processing task defined with any given XSA is done with Sink modules which define what to do with the processed XML data received from a Transformer. Different types of Sinks perform different tasks depending on the purpose of the XSA. A common task is to somehow publish or deliver the processed XML data, often in non-XML format, back to the client, which requested the execution of the XSA. Some Sinks might interpret the XML data they receive, to determine if and how to react to it, for example by performing some action. One example of a Sink outputs its XML input data as HTML or WML, another publishes it as a PDF electronic document. Other types of Sinks might cause the resulting XML to be delivered over the Internet as XML business document; still others might use information in the XML they receive to determine if to perform tasks such as sending an email for notification purposes or writing data to a database or sending it to another system for integrating purposes.

As described above, the present invention includes a system for execution of XML Service Action electronic documents, preferably written in a special purpose programming language according to an XML Service Action specification, which accurately defines valid syntax for XSA in the spirit of the present invention. The system includes an XSA Engine, which is decoupled from any specific application context and provides only a generic interface. According to a preferred embodiment of the present invention, the system relies on software modules, herein referred to as Adapters, to adapt to a specific application context. Adapters are responsible for accepting requests or invocations for execution of specific XSA-s from various types of external clients, such as networked devices, wireless devices or other computer systems. Adapters are software modules that handle all communications with the external client, thereby encapsulating all the application- or context specific communication, generally adapting to a specific type of communication protocol, and interact with the XSA Engine through its generic interface by requesting execution of a specific XSA. An adapter component therefore adapts the generic XSA engine to a specific application context. For each XSA execution request, the Adapter component, through which the request arrives, defines the context in which the XSA executes. It provides the link from the real world of computing applications, which might benefit from specific XML processing tasks, to the XSA Engine. Through the generic interface provided by the XSA Engine, the Adapter may provide the XSA Engine with information related to the incoming request, possibly in an XML based format or in the form of parameter name-value pairs. When execution of an XSA is finished, an appropriate response is generally sent to the requesting external client back through the Adapter component which invoked the XSA engine, based on the result of the processing as defined in the particular XSA in question. Specific Generators, Transformers or Sinks might impose restrictions on which specific types of Adapters they are compatible with.

Any XSA may use specific types of Generators, Transformers and Sinks in a variety of ways to accomplish the desired XML processing task. The XML processing defined in an XSA may, for example, take place in more than one thread of execution through merging or splitting of XML electronic documents. An XSA Engine may rely on many different types of software modules to provide for the possibility of flexible and sophisticated processing and flow of XML data using the three classes of XML processing modules described above. These software modules might provide auxiliary or supportive functions such as: Error handling, validation, access to meta data related to a specific XSA execution, session control, user management, authentication, authorization, and other similar auxiliary functions.

XML Service Actions can be used to accomplish vastly different computing tasks in vastly different applications. More or fewer system components can also be used, and the present invention is not limited to the system components described. The present invention does not necessarily mandate the existence of any specific software components. It describes a method and a system for execution of XML processing tasks, defined by XML Service Action electronic documents written in a special purpose programming language, solely defined for management and linking of well-defined XML processing subtasks. It uses specific implementations of abstract processing modules described herein to accomplish its desired function. Even though the present invention is herein always described in terms of XML processing tasks the method and a system might equally well be applied to any processing of structured data, not necessarily in XML format. To be useful in the real world, implementation of specific software modules or components according to a specification for a special purpose programming language, that accurately defines the format of XML Service Action electronic documents and the processing modules it controls must be provided.

In accordance with preferred embodiments of the present invention, each XML Service Action electronic document is written in a special purpose programming language, defined to be in a specific syntax, which may or may not be XML-based. An XSA Engine is responsible for interpreting and executing XSA electronic documents, which may be available to the XSA engine either through dynamic generation or by retrieving it from a requesting client or some storage in a computer system. A system capable of executing XML Service Action electronic documents written in a special purpose programming language, valid according to a specification written in the spirit of the present invention, could be implemented in a regular computer system.

The XSA framework, decoupled from any specific execution context, provides a standardized, structured, flexible and sophisticated means to better or more easily solve many problems within the fields of publishing, business messaging, Enterprise Application Integration and other fields where there is value in processing or manipulating structured data.

The XSA framework is complementary to existing technologies. It is a framework for management of XML processing tasks and not a replacement for any particular type of existing XML processing technology. It does not, for example, define how XML documents are transformed; specific embodiments may use any existing method for that purpose. By requiring and utilizing a high-level special purpose programming language, specifically designed for management of XML processing tasks, It diminishes or even eliminates the need for creating custom code in a general purpose programming language to glue together XML processing subtasks, where each subtask is governed by a well-known XML processing standard, specification or method. An appropriate analogy might be this; consider an XSLT engine, an XML validator, an HTML-to-XML converter, an XML serializer or any other module performing a particular type of XML processing subtask to be programs. Then an XSA Engine is analogous to the operating system that coordinates the interoperation of these programs. An XSA Engine, capable of interpreting and executing XSA electronic documents written in the special purpose programming language, can be considered an implementation of the general spirit of the XSA framework described herein, thus the XSA framework might be thought of as analogous to an operating system family or standard.

In one particularly preferred embodiment of the present invention, the method and a system are used to enable a wireless device to request information in an electronic document in format, which that device can understand. A specific XSA might be invoked to run within an XSA Engine, through a suitable Adapter (e.g. HTTP adapter), capable of communicating with the device. The XML processing task defined in this XSA might retrieve data from a back-end system, convert it to XML format using a specific type of Generator, transform it using a Transformer to a format suitable for the requesting device and finally a Sink may deliver it to the device through the Adapter.

For example, according to a preferred embodiment of the present invention, information about the current weather may be requested from a wireless device by using Hypertext Transfer Protocol (HTTP) compliant browser software to navigate to a specific URL. An XSA Engine may have access to a specific XSA electronic document, which defines how to derive the desired response from the information obtained from a weather data source, and deliver it to the requesting device through an HTTP Adapter. The request Is received by the HTTP Adapter, capable of communication with the requesting client through HTTP. The adapter then invokes the XSA Engine, which starts execution of the specific XSA requested. This XSA contains a reference to a specific type of Generator, which is able to connect to the weather database. The instructions found in the XSA instruct the Generator to retrieve the relevant weather data and then it is converted to XML source data. The XSA may further contain reference to, and instructions for, one or more specific types of Transformers (e.g. a Transformer which transforms XML using XSLT), resulting in transformation of the XML source data to form an XML electronic document in a Wireless Mark-up Language (WML) format suitable for display by the browser in the requesting device. The XSA finally contains references to, and instructions for, a specific type of Sink, which is able to deliver the WML electronic document to the requesting device through the HTTP Adapter module. The specific XSA electronic document in question is written in a special purpose programming language, which may be accurately defined in an XSA programming language specification. However, the present invention is not limited to HTTP communications, wireless devices or databases. Other data, protocols, network devices or external systems could also be used.

The foregoing and other features and advantages of preferred embodiments of the present invention will be more readily apparent to those skilled in the art upon consideration of the detailed description of embodiments of the invention in conjunction with the accompanying drawings.

### BRIEF DESCRIPTION OF THE DRAWINGS

In order to more fully understand the manner in which the above-recited and other advantages of the invention are obtained, a more in-depth description of the invention will be rendered with references to appended drawings. Furthermore, description of specific embodiments of the invention will be illustrated also with references to the appended drawings. Understanding that these drawings depict only typical embodiments of the invention and are therefore not to be considered limiting of its scope, the accompanying drawings will be used to describe the invention, and the presently understood best mode for making and using it, with greater detail for the sake of illustration only.

FIG. 1 is a block diagram of an example generic system that provides a suitable operating environment for the present invention.

FIG. 2 is a block diagram illustrating the major types of modules controlled by an XML Service Action written in a special purpose programming language, specifically designed for management of XML processing tasks.

FIG. 3 is a block diagram illustrating the execution of XML processing tasks defined by XML Service Actions, written in a special purpose programming language.

FIG. 4 is a flow diagram illustrating the flow of execution of XML Service Actions.

FIG. 5 is a block diagram illustrating the role and typical structure of Generators as defined by the XML Service Action model.

FIG. 6 is a block diagram illustrating the role of Transformers as defined by the XML Service Action model.

FIG. 7 is a block diagram illustrating the role of Sinks as defined by the XML Service Action model.

### DETAILED DESCRIPTION OF THE INVENTION

The embodiments described herein are not intended to be exhaustive or to limit the invention to the precise forms disclosed. Rather, the embodiments selected for description are described so that those skilled in the art may utilize their teachings. Most notably, although XML processing is frequently referred to herein, the invention is not limited to XML processing or XML server-side applications but can equally be applied to processing of any type of structured data.

The following discussion is intended to provide a brief, general description of a suitable computing environment in which the invention may be implemented. Although not required, the invention will be described in the general context of computer-executable instructions, such as program modules, being executed by a personal computer. Generally, program modules include routines, programs, objects, components, data structures, etc., that perform particular tasks or implement particular abstract data types. Moreover, those skilled in the art will appreciate that the invention may be practiced with other computer system configurations, including hand-held devices, multi-processor systems, microprocessor-based or programmable consumer electronics, network PCs, minicomputers, mainframe computers, and the like. The invention may also be practiced in distributed computing environment where tasks are performed by remote processing devices that are linked through a communications network. In a distributed computing environment, program modules may be located in both local and remote memory storage devices.

As used herein, the term “software module” or “module” refers to any set of executable instructions separately cognisable to perform a specific logical function within a computer program.

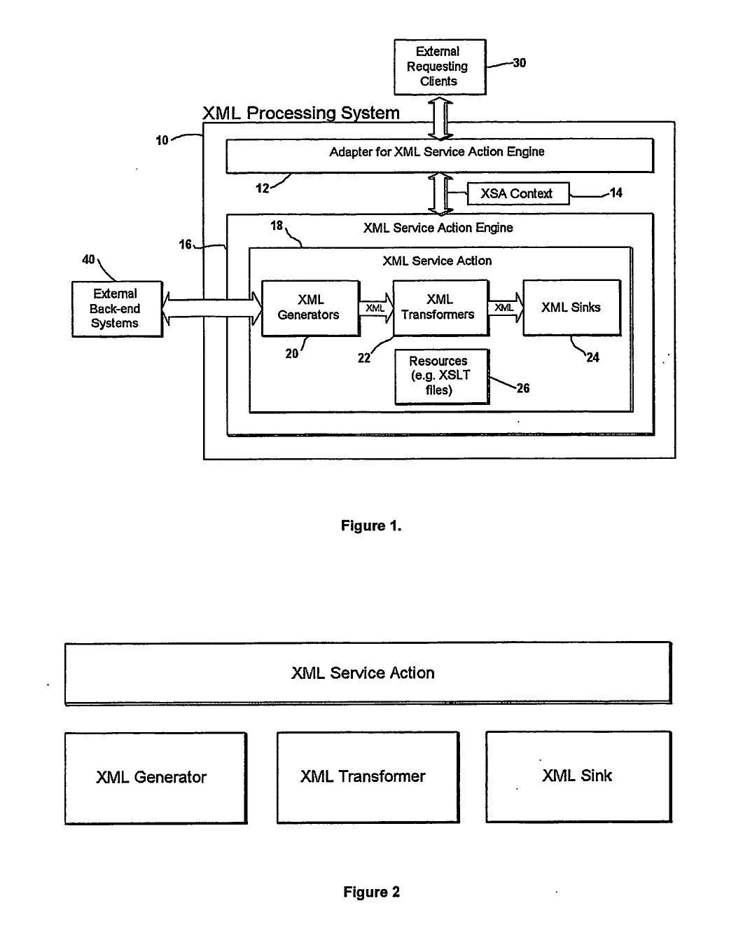

FIG. 1 is a block diagram, which depicts the basic components of an XML Processing system 10. XML Processing system 10 generally includes an XSA engine 16, which provides a generic interface, and one or more Adapter modules 12, which enable external clients to interact with the XSA Engine 16. The XSA Engine 16 is capable of executing instructions encoded in XSA electronic documents 18 using a special purpose programming language designed for management of XML processing task. Since the XSA Engine 16 offers only a generic interface, invocation of the XSA Engine 16 happens through adapter components 12, which can communicate with some type or types of external clients 30 on one hand, and with the XSA Engine 16 on the other hand. Each invocation or request from an external client 30 must contain information or data, which can be used by the Adapter module 12 to determine which XSA electronic document 18 to execute. Upon receiving a request or invocation, the Adapter module 12 may provide the XSA Engine with information about the origin and purpose of the request. This information, accessible to the XSA Engine, is here represented with a Context module 14, which the XSA Engine 16 utilizes to initialise and execute the XML processing tasks defined in the requested XSA Electronic Document 18 written in a special-purpose, well-defined, high-level programming language, specifically designed for management of XML processing tasks. Having such a special-purpose, high-level programming language means that creating of specific XML processing tasks can be made much easier and more rapidly than possible with general purpose programming languages. Although only applicable to XML processing tasks, creating such tasks can be made much faster and easier with a specific purpose programming language. Software programs might also be created which enable developers to create specific XSA documents through high-level interfaces, perhaps based on graphical user interfaces, even eliminating totally the need for writing custom code directly. Developer's interaction with such a high-level interface, perhaps utilizing graphical components, might make it possible to generate specific XSA-s without any need for writing any text-based code.

The present invention divides XML processing tasks into three classes of XML processing steps or subtasks: XML Generation, XML Transformation and XML Delivery/Reaction. This is reflected in the fact that each XSA electronic document 18 generally contains references to specific implementations of three classes of XML processing modules, each class corresponding to one of these subtasks. XML Generator modules 20 are responsible for connecting to external back-end systems 40 and expose their content, services and/or business logic as XML data available for further processing by XML Transformer modules 22. This step often involves both connecting to an external system and defining a mapping from the external system's native data-structure to an XML format. XML Transformer modules 22 transform the XML data received from XML Generators 20 to a different XML format. An XSA electronic document 18 may define more than one XML Transformer in sequence (as described in more detail later) for sequential processing of XML data. XML Sink modules 24 react to or deliver the XML data they receive from XML Transformer modules 22. Each of these three abstract XML processing module types have access to Meta information, represented here by a dynamic XSA context module 14, provided by the Adapter module 12. The Meta information in the XSA Context module 14 is provided by the Adapter module 12 before execution of a specific XSA starts and persists throughout the execution of the XSA. It is accessible to all modules, which take part in the execution. The Meta information represented by the Context module 14 defines the context in which an XSA executes. Each of the three abstract XML Processing module classes may also have access to a passive resource repository 26 where various resources in electronic format are stored in a storage-medium. An XSA electronic document may define and control one or more XML Generator modules, zero or more XML Transformer modules, and one or more XML Sink modules.

FIG. 2 is a block diagram which depicts how an XSA electronic document defines one discrete XML Processing task by referencing specific Generators, Transformers and Sinks, and managing their interoperation as specified in a specific-purpose, high-level programming language, designed for management of XML processing tasks.

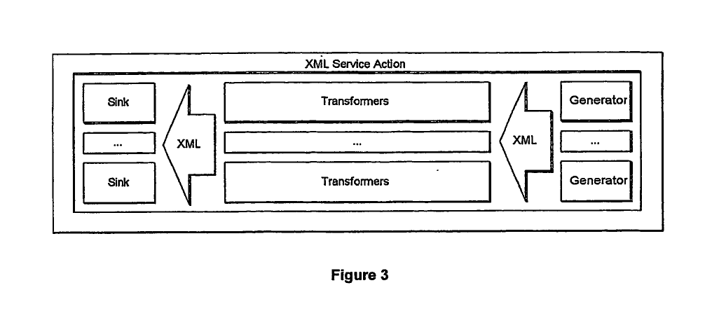

FIG. 3 is a block diagram, which illustrates the execution of XML processing tasks when an XSA electronic document is being executed. The figure also indicates the flow of XML data from Generators to Sinks, being subjected to zero or more Transformers in-between.

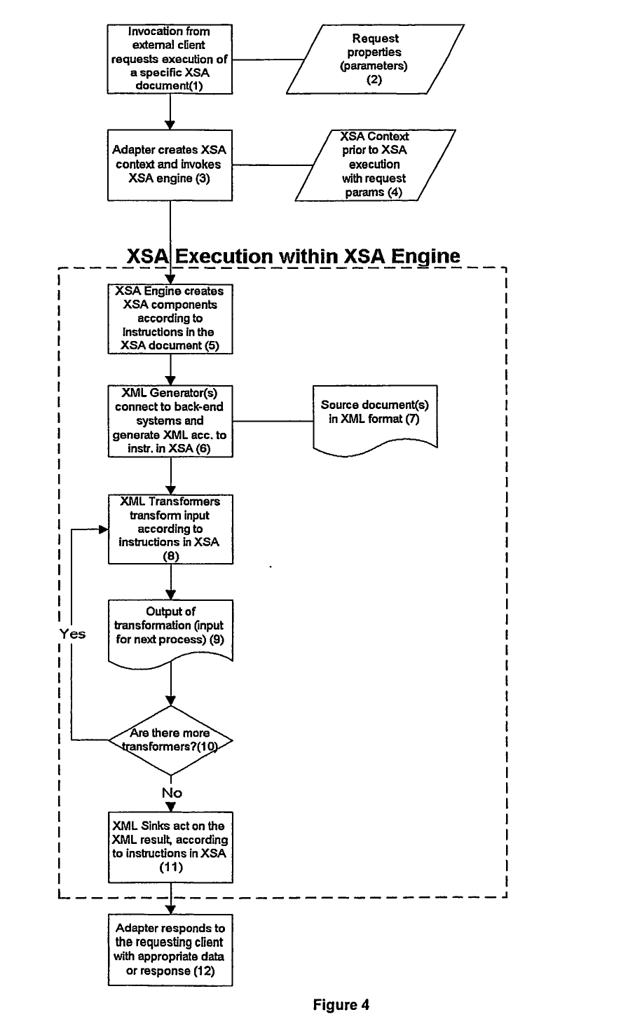

FIG. 4 is a flow diagram illustrating the sequence of events that initiate and complete the execution of an XSA within an XML Processing system according to the present Invention. An invocation or a request from an external client takes place (1). The request contains information, which can be used to determine which XSA electronic document to execute and may contain other context-sensitive information. All request information, implied or direct, may be referred to as request properties (2). A specific Adapter module, capable of communication with the requesting client, receives the request and defines the context of XSA execution (3) by providing the XSA Engine with an XSA Context module (4) where appropriate context sensitive information can be accessed. The Adapter module initialises the execution of a specific XSA within an XSA Engine module. The XSA Engine uses information in the XSA Context module to prepare the execution of the requested XSA electronic document (5) which is written in a special purpose programming language. Specific types of Generators defined in the requested XSA generate XML source content according to instructions in the given XSA (6), generally by communicating with some external back-end system and transforming data obtained to XML. The result is XML source data (7) before processing takes place. Next, zero or more XML Transformers (8) transform the XML source data according to instructions in the requested XSA, resulting in a different type of XML data (9). Finally XML Sink modules finish the XML processing task by somehow delivering or reacting to the XML content. (11) This step may or may not involve interpretation of the processed XML data. Generally some kind of response is sent back to the requesting client through the Adapter module as a result of the task being completed by the XML Sink (12).

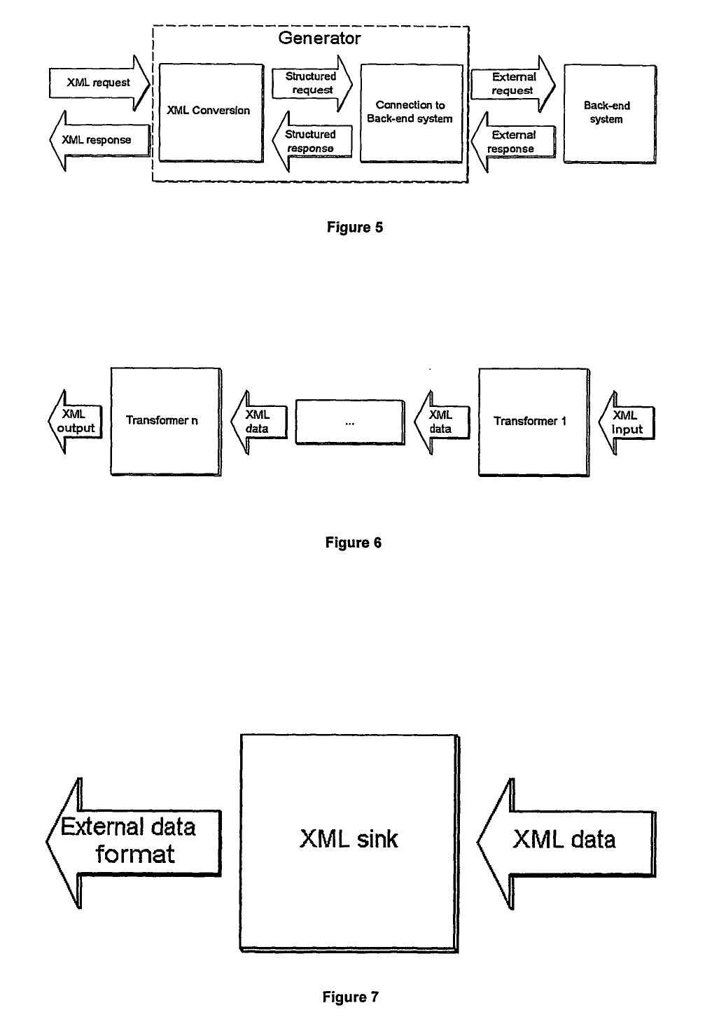

FIG. 5 is a block diagram illustrating the role, and typical structure, of Generators as defined by the XML Service Action model. The drawing illustrates that Generators generally face the twofold task of first connecting to an external system and then exposing data from the external system in XML format.

FIG. 6 is a block diagram illustrating the role of Transformers as defined by the XML Service Action model. The drawing illustrates that any number of Transformers may be applied in sequence and that each one has XML data both as input and output.

FIG. 7 is a block diagram illustrating the role of Sinks as defined by the XML Service Action model. A Sink generally either transforms the XML input data to some external data format to be delivered or published to the requesting client or somehow interprets and reacts according to the processed XML input. The reaction might be anything, depending on the Sink's purpose, and might not necessarily involve responding to the requesting client at all.

One preferred embodiment of the invention is a presentation system, which facilitates publishing data residing in back-end systems to many different types of networked clients with incompatible presentation needs, e.g. many different types of mobile devices. The presentation system includes Adapter modules capable of communicating with the clients, e.g. through the HTTP protocol. The presentation system also comprises specific types of Generator modules capable of communicating with the back-end system(s) and exposing the back-end system data in XML format. This presentation system also contains specific types of Transformer modules capable of transforming the generic source XML data from the back-end system to many different formats suitable for display in each of the networked client devices. The system also contains Sinks capable of delivering the tailored version of the content back to the requesting client device through the adapter from which the request came. The system also contains specific XSA electronic documents, written in a special purpose programming language, which manage the processing of the XML data and make sure appropriate Generators, Transformers and Sinks are used depending on which client makes a request for content. The presentation system is inherently extensible by virtue of the XSA framework, and encourages full separation of raw content data from presentation information. Supporting new back-end systems, new clients or even new communication protocols entails simply adding a new Generator, Transformer or Adapter.

Another embodiment of the invention is a messaging system, which delivers business messages, generally In a secure manner, from one external system to another over the Internet using a standardized business messaging protocol, such as ebXML or BizTalk. This system requires an Adapter module capable of communicating using the protocol in question. The system also contains specific types of Generator modules capable of extracting data in XML format from the communicating systems. Furthermore it may contain various Transformers capable of turning the system data into a business message ready for delivery. The system also contains specific Sink modules capable of delivering the message to its destination through the appropriate Adapter module. The system may also contain specific types of Transformer capable of translating between different standards of business messages. Finally the system contains specific XSA electronic documents, written In a special purpose programming language, which manage and control the XML processing, and an XSA Engine capable of executing those documents when a request to do so occurs.

Yet another embodiment of the invention is an integration system capable of integrating data between heterogeneous source and destination applications. This kind of integration system comprises an XSA Engine, specific XSA electronic documents, written in a special-purpose programming language, specific Adapter modules which are able to communicate with the source and destination applications, specific Generators capable of transforming the native data structures of the source and destination applications into an XML format, specific Transformers capable of transforming the XML input from the source application to an XML format suitable for delivery into the destination application, and finally Sink components capable of delivering the processed (transformed) XML data to the destination application.

Following is a detailed description of still another preferred embodiment of the present invention, hereafter referred to as embodiment A. Embodiment A is a specification for a special-purpose programming language that accurately defines one possible format for XML Service Action electronic documents and explains their semantics and how it should be interpreted by an XSA Engine implementation written according to the specification defined by embodiment A. Embodiment A can be described as an exemplary XML Service Action specification for a special-purpose programming language, designed for management of XML processing tasks, which those skilled in the art might utilize to create a specific implementation of the present invention in a regular computer system. Embodiment A might be used as a precisely stated framework for all of the other embodiments described above.

According to embodiment A, XSA electronic documents are written in a special purpose programming language, based on XML format according to a Document Type Definition (DTD). An XML electronic document, which constitutes a valid XSA, document, will herein sometimes be referred to as an XSA definition.

Following are definitions of terms used in the description of embodiment A:

XSA Execution Engine: A software implementation capable of running XSA Definitions as defined for embodiment A.

XSA Definition: Each XSA to be executed is specified as an XML document. The location or form of the document Is not restricted in any way by the specification of embodiment A, it can be read from a storage-medium or be machine-generated at runtime or obtained in any other manner. An XML document which describes one instance of an XSA as defined for embodiment A is called an XSA definition.

XML Operation: Each XSA Definition is composed of a number of XML operations. An XML operation is a unit of execution within the XSA, and they are executed sequentially as defined in the XSA Definition.

XSA Component Components used in XML Operations are called XSA components. Examples of XSA components include the blocks of an execution Pipeline such as Generators, Transformers and Sinks.

XSA components are always referenced within XSA definitions, but the actual component to use is defined outside of the XSA definition, giving implementers complete freedom in the programming language, implementation and configuration of the components to use.

Generator A Generator is a component that generates XML data in some specific way. The methods the generator uses to create the XML depend on the implementation of the generator component being used.

Transformer: A Transformer is a component that transforms XML data in some specific way. The methods used to transform the XML depend on the implementation of the transformer component being used.

Sink: A Sink is a component that delivers XML data after processing. Delivery can be anything from keeping the XML data in an internal form in memory to serializing it to some external format to putting it into a database.

Pipeline: A pipeline combines a Generator, a sequence of Transformers, and a Sink, to form a sequence of execution. XML data flows from the Generator, through the Transformers and to the Sink.

Conditional Operations: Conditional operations can be used to control the execution flow, deciding which Pipeline is executed.

XSA Context: Each XSA execution runs in a context, which gives access to a set of named variables through several named Scopes.

Scope: An XSA Context stores all named variables in scopes. The scopes are request, session, client, user and application. Each scope has a semantic meaning as defined later in this specification for embodiment A.

Variable: The term variable is used for name-value pairs stored in the XSA Context. A variable has a name and a value and belongs to a certain Scope.

Following is a description, according to embodiment A, of the basic syntactic elements of an XSA definition, which are used to define XML Operations.

Each XSA definition written according to this specification of embodiment A must include a DOCTYPE declaration with the public identifier set to “−//Dimon//DTD XSA 1.1//EN”. This DTD is as follows:

```
<!--
  XML Service Action specification for embodiment A
  Namespace = http://www.dimon.is/namespaces/xsa
  This DTD module is identified by this PUBLIC identifier:
  PUBLIC “-//Dimon//DTD XSA 1.1//EN”
  and this canonical system identifier
  SYSTEM “http://www.dimon.is/dtds/xsa/1.1/xsa.dtd”
  The system identifier may vary. A DOCTYPE declaration might look like:
  <!DOCTYPE xsa PUBLIC “-//Dimon//DTD XSA 1.1//EN” “xsa.dtd”>
    REVIEW: DRAFT
-->
<!--Refers to the ID of a component defined and configured elsewhere in the server.-->
<!ENTITY % refid “refid CDATA #required”>
<!--Specification of a named variable in a given scope-->
<!ENTITY % variablespec”
  scope (request|session|client|user|application) #required
  name CDATA #required”>
<!--A general subpart of an action-->
<!ENTITY % XMLOperation “(pipeline|setvariable|removevariable|if|operation)”>
<!--Any specifier of a value. The out-param-value is a special case,
it can only be used as a descendant of out-param. The others can be
used wherever valuespec is in the content model.-->
<!ENTITY % valuespec “(null|literal|getvariable|mapping|out-param-value)”>
<!--Collective representation of conditions-->
<!ENTITY % anycondition “(and|or|not|isdefined|isoftype|equals|condition)”>
<!--Collective representation of input/output parameter assignments.-->
<!ENTITY % inoutparam “(out-param|in-param)”>
<!--The root element of any action specification-->
<!ELEMENT xsa (supports*,errordef*,(%XMLOperation;)+)>
<!ATTLIST xsa
  version CDATA #required
  xmlns CDATA ‘http://www.dimon.is/namespaces/xsa’
>
<!-- Indicates support for a given adapter. If no supports element appears,
then any adapter can assume that it can invoke this XSA.
-->
<!ELEMENT supports EMPTY>
<!ATTLIST supports
  adaptername CDATA #required
>
<!--Defines an error, and what XSA to invoke in case of this error.
The content can be a descriptive error message, in English.
The name attribute is the name of the error, and invokes should give a
reference to the XSA to invoke in case of this error.
-->
<!ELEMENT errordef #PCDATA>
<!ATTLIST errordef
  name CDATA #required
  invokes CDATA #required
>
<!--Represents the operation of executing an XML pipeline.
The generator, transformers, and the sink, are specified by nested elements.-->
<!ELEMENT pipeline ((generator|raiseerror),(transformer|raiseerror)*,(sink|raiseerror))>
<!--Represents the operation of setting a variable in a scope.
The contents specify the value to set.-->
<!ELEMENT setvariable (%valuespec;)>
<!ATTLIST setvariable
  %variablespec;
  failonerror (true|false) “true”
>
<!--Represents the operation of removing a variable in a scope.-->
<!ELEMENT removevariable EMPTY>
<!ATTLIST removevariable
  %variablespec;
  failonerror (true|false) “true”
>
<!--Represents the operation of executing each operation in
one of two lists of operations, after choosing between
those lists by evaluating a condition.-->
<!ELEMENT if (%anycondition;,then,else?)>
<!--Container for XMLOperations to be executed when
a conditional evaluates to true.-->
<!ELEMENT then ((%XMLOperation;)*)>
<!--Container for XMLOperations to be executed when
a conditional evaluates to true.-->
<!ELEMENT else ((%XMLOperation;)*)>
<!--Represents instantiation of a generator initiating a SAX chain.
Refers to a generator factory configured elsewhere, and specifies
the parameters to invoke it with-->
<!ELEMENT generator ((%inoutparam;)*)>
<!ATTLIST generator
  %refid;
>
<!--Represents instantiation of a transformer as part of a SAX chain.
Refers to a transformer factory configured elsewhere, and specifies
the parameters to invoke it with-->
<!ELEMENT transformer ((%inoutparam;)*)>
<!ATTLIST transformer
  %refid;
>
<!--Represents instantiation of a sink terminating a SAX chain.
Refers to a sink factory configured elsewhere, and specifies
the parameters to invoke it with-->
<!ELEMENT sink ((%inoutparam;)*)>
<!ATTLIST sink
  %refid;
>
<!--Raises an error, if the XPath evaluates to TRUE.
The error attribute should contain the name of the error to raise
and the test attribute should contain the XPath to evalute.-->
<!ELEMENT raiseerror EMPTY>
<!ATTLIST raiseerror
  error CDATA #required
  test CDATA #required
>
<!--Represents getting the value of a given variable-->
<!ELEMENT getvariable EMPTY>
<!ATTLIST getvariable
  %variablespec;
>
<!--Refers to a condition defined elsewhere
It may take input parameters, assigned by nested in-param elements.-->
<!ELEMENT condition (in-param*)>
<!ATTLIST condition
  %refid;
>
<!--AND condition, yields true if and only if all nested
conditions yield true.-->
<!ELEMENT and ((%anycondition;)+)>
<!--Inclusive-OR condition, yields true if and only if
one of the nested conditions yields true.-->
<!ELEMENT or ((%anycondition;)+)>
<!--Negation condition, yields the negation of a nested condition.-->
<!ELEMENT not ((%anycondition;))>
<!--is-defined condition, yields whether all nested values (any Object) are non-null.
  Yields true in the degenerate case of no nested values.-->
<!ELEMENT isdefined ((%valuespec;)*)>
<!--is-of-type condition, yields whether the first nested value (any Object) is of the class
named by the
  second nested value (a String). Yields false if either is null.-->
<!ELEMENT isoftype ((%valuespec;),(%valuespec;))>
<!--equals condition, yields whether the first nested value is equal to each of the others, as
determined
  by the equals method. Yields true if all are null. Yields false if some are null and some
aren't.
  Yields true in the degenerate case of only one nested value.
  -->
<!ELEMENT equals ((%valuespec;)+)>
<!--Represents assigning a value to a named input parameter-->
<!ELEMENT in-param (%valuespec;)>
<!ATTLIST in-param
  name CDATA #required
>
<!--Represents a mapping that takes one or more input
parameters, and yields a resulting value. The
input parameters are given by nested in-params.-->
<!ELEMENT mapping (in-param*)>
<!ATTLIST mapping
  %refid;
>
<!--Represents assigning an output parameter to a variable-->
<!ELEMENT out-param (setvariable)>
<!ATTLIST out-param
  name CDATA #required
>
<!--Represents the value of the output parameter when used
as a descendant of an out-param element. Illegal anywhere
else.-->
<!ELEMENT out-param-value EMPTY>
<!--Represents the value null (duh).-->
<!ELEMENT null EMPTY>
<!--Represents a value specified literally.-->
<!ELEMENT literal (#PCDATA)>
<!--Represents a custom XMLOperation to be constructed by the given parser class.
The parser class must be present in the XSA parser classloader, and must have a
default constructor.
This element might contain arbitrary XML. Either that XML should be in a separate
namespace (to avoid trouble with this DTD), or this DTD should not be enforced at
parse time.
-->
<!ELEMENT operation EMPTY>
<!ATTLIST operation
  parserClass CDATA #required
>
```

An example DOCTYPE declaration is as follows:

```
<!DOCTYPE xsa
  PUBLIC “-//Dimon//DTD XSA 1.1//EN”
  “http://www.dimon.is/dtds/xsa/1.1/xsa.dtd”>
```

The root element of the XSA definition is <xsa>. It must contain a version attribute with the value of 1.1 if the XSA is written according to this specification of embodiment A. The XSA namespace URI is http://www.dimon.is/namespaces/xsa. An example root element that is empty can be as follows:

<xsa version=“1.1” xmlns=“http://www.dimon.is/namespaces/xsa”>
</xsa>

Inside the root, the XSA definition contains any number of elements as covered below. Most of these elements correspond to XML operations. The types of XML operations are covered in detail later below but the following list briefly describes each type of XML element allowed inside the root element according to embodiment A of the present invention.

Pipelines: Pipelines are defined by the <pipeline> element. Pipelines combine Generators, Transformers and Sinks, the basic elements used for processing XML data.

Variables: Manipulated by the <setvariable> and <removevariable> elements, and accessed by the <getvariable> element, variables are the means of passing control information externally into and out of the XSA execution, and internally between the components of the XSA.

Variables are a part of the XSA context, which is covered in detail below.

Conditions: Conditions are defined by the <if> element. They can be used to control which XML operations are executed and which not.

Custom operations: Custom operations are defined by the <operation> element. They can be used to create any custom XML operation.

The syntax of each XML operation is covered later. An example XSA definition according to the specification of embodiment A can be as follows:

```
<?xml version=‘1.0’?>
<!DOCTYPE xsa
          PUBLIC “-//Dimon//DTD XSA 1.1//EN”
          “http://www.dimon.is/dtds/xsa/1.1/xsa.dtd”>
<xsa version=“1.1” xmlns=“http://www.dimon.is/namespaces/xsa”>
  <setvariable scope=“request” name=“http.response.Content-Type”>
    <literal>text/plain</literal>
  </setvariable>
  <pipeline>
    <generator refid=“index”/>
    <transformer refid=“resourcetrax”>
      <in-param name=“xsl”>
        <literal>index.xsl</literal>
      </in-param>
    </transformer>
    <sink refid=“clipsersink”>
      <in-param name=“outputStream”>
        <getvariable scope=“request” name=“http.responsestream”/>
      </in-param>
    </sink>
  </pipeline>
</xsa>
```

According to the specification of the special purpose programming language described in embodiment A, XSA definitions are executed in a linear order. This means that each XML operation is evaluated completely before the next XML operation in the list is evaluated. Implementations must adhere to this ordering since variable setting can depend on the order of execution.

Following is a description of the execution context of embodiment A.

An XSA is executed in order to activate the processing defined in the XSA definition. Each XSA execution has access to an XSA context, which exposes a set of variables defined in scopes. No particular variable names are defined in this specification, but all variables must belong to one of the following named scopes.

This specification of embodiment A does not define the read/write access to specific variables, regardless of their scope. An implementation may restrict access to certain variables as necessary to fulfil its requirements, an example would be to allow read access to variables in the user scope but not write access. When set restrictions are violated, an error must be raised, and the error handling described below must be invoked accordingly. What error is raised is an implementation detail.

Setting variables in the XSA Context must overwrite the value previously in that variable (if any value exists), as long as writing to that variable is allowed by the implementation. The following scopes are defined in this specification of embodiment A. The mapping of these scopes to the runtime environment is up to the implementation according to this embodiment A specification. The mappings implemented must follow the descriptions given below.

Request The request scope is required to survive the current XSA execution but not any longer than that. It may contain data initialised by the invoker of the XSA, and the XSA execution may modify variables defined in this scope. All implementations must support the request scope.

Session: The session scope is required to survive between requests as long as the same session is being used. The definition of a “session” is left to the implementation, but obvious example is HTTP sessions in case of a web server using the XSA model. It is optional to support the session scope.

Client: The client scope is used for data, which applies to the client invoking the XSA either directly or indirectly. The definition of a client is left to the implementation, but an example is the browser invoking a web page using the XSA model. It is optional to support the client scope.

User The user scope is used for data relevant to the user identity (typically human) invoking the XSA either directly or indirectly. It is optional to support the user scope as the notion of a user might not apply to many implementations of this specification of embodiment A. Even if an implementation does support user identification, the user scope is optional.

Application: The application scope is used for data relevant to the application the XSA is running in. The definition of an application is left to the implementation of the XSA specification. It is optional to support the application scope.

The specification for embodiment A of the present invention states that the scopes of variables form together what is called an XSA Context. An XSA Context is usually initialised before XSA execution, but may be reused between XSA executions if so desired. In that case, the implementation must define clearly when the XSA Context is being reused and in what cases, as to avoid potential security holes.

Following is a detailed description of the concept of Pipelines for embodiment A of the present invention

A pipeline defines a sequence of XML Generators, Transformers and Sinks. The pipeline element is the main XML Operation of an XSA definition.

A pipeline is defined by the <pipeline> element. It contains an ordered list of elements, beginning with a mandatory Generator, followed by any number of transformers, and terminated by a Mandatory sink.

The data flow can be seen as beginning in the Generator, which creates the XML document(s) to be processed, going through the Transformers, which may modify the structure and content of the XML data, and finally ending in the Sink, which delivers or react to the data in the form specified.

The data flowing between the various parts of the pipeline is in XML form. The implementation is not required to keep this data in any specific form, common APIs such as SAX and DOM might be used. In addition to data flowing between the components, input and output parameters can be used for each component. The evaluation order of these parameters is not restricted by this specification, meaning that an output parameter from a component early in a pipeline might or might not be available for input to a component later in the pipeline. The only restriction is that the pipeline must complete its parameter evaluation and execution before the next XML operation in the XSA is run.

As with other XML Operations according to embodiment A of the present invention, a pipeline is made up of XSA Components. Following is a description of the XSA Component types used in pipelines, beginning with a description of the common attributes of all the component types.

XSA Components are used in pipelines to perform some form of work within the pipeline execution. XSA components are defined externally and referred to from the XSA definition. The method used to define an XSA component, the naming methods used to refer to an XSA component and the interface implemented by the XSA component are implementation details not covered by this specification of embodiment A.

The name of the component instance to use is given in the refid attribute of the XSA component. This reference must always refer to the same object instance as defined by the programming language in use, and if the object is modified in some way, all XSA definitions referring to it must be updated accordingly.

In addition to being referred to eternally, XSA components share one more common ability; input and output parameters.

Each XSA component can define any number of named input and output parameters. Within the XSA definition, an input parameter is given with the <in-param> element, and an output parameter is given with the <out-param> element.

The format of the <in-param> element is as follows.

<in-param name=“xsl”>
<!-- Value specification -->
</in-param>

The format of the <out-param> element is as follows:

```
<out-param name=“xsl”>
  <setvariable ...>
    ...
  </setvariable>
</out-param>
```

The name of each input and output parameter is defined by the component implementation.

Following is a description of Generator components as specified for embodiment A of the present invention.

A Generator is an XSA Component used to create XML data to be processed in the pipeline. How the generator creates the XML is implementation-specific; examples include reading the XML from a file, fetching it over a network, and accessing a database and converting the data into XML. The generator's output is required to be at all times well formed in the implementation's internal representation of XML. The XSA Execution Engine may enforce this requirement on each generator but is not required to.

Generators are always defined at the beginning of a pipeline and are required in all pipelines. The <generator> element is used to define a generator in a pipeline. As with all XSA components, Generators support named input and output parameters. The form of the <generator> element is as follows:

<generator refid=“mygen”>
<in-param name=“myinparam”>
...
</in-param>
...
<out-param name=“myoutparam”>
...
</out-param>
...
</generator>

Following is a description of the Transformer components as specified in embodiment A of the present invention.

A Transformer is an XSA component used to transform data from one XML form to another. How the Transformer processes the XML is implementation-specific, examples include using XSLT, applying custom coded modifications to text nodes, sorting, validation, etc. The Transformer output is required to be at all times well-formed in the implementation's internal representation of XML, and its input is also well-formed as it comes either from a generator or another transformer, both which are required to generate well-formed XML. The XSA Execution Engine may enforce this requirement on each transformer but is not required to. Transformers are not required in a pipeline definition; when they occur, they always occur after the Generator and before the Sink. The <transformer> element is used to define a Transformer in a pipeline. As with all XSA components, Transformers support named input and output parameters. The form of the <transformer> element is as follows:

```
<transformer refid=“mytran”>
  <in-param name=“myinparam”>
    ...
  </in-param>
  ...
  <out-param name=“myoutparam”>
    ...
  </out-param>
  ...
</transformer>
```

Following is a description of the Sink components as specified in embodiment A of the present invention.

A Sink is an XSA Component used to handle the internal representation of the XML data resulting from the processing performed in a pipeline. What the Sink does with the XML is implementation-specific, examples include writing the XML to a file, sending it as HTML to a web browser, or generating PDF from it. As either a Generator or a Transformer always generates the input to a sink, it is well formed. No restrictions are set on the output from the sink.

Sinks are always defined at the end of a pipeline and are required in all pipelines. The <sink> element is used to define a sink in a pipeline. As with all XSA components, sinks support named input and output parameters. The form of the <sink> element is as follows:

```
<sink refid=“mysink”>
  <in-param name=“myinparam”>
    ...
  </in-param>
  ...
  <out-param name=“myoutparam”>
    ...
  </out-param>
  ...
</sink>
```

Following is a description of variables and value specifications according to the XSA specification of embodiment A of the present invention.

Variable operations in XSA always apply to variables in the XSA Context.

On the root level of an XSA Definiton and within conditions, variables can be set and removed. Variables are set with the <setvariable> element, and removed with the <removevariable> element. The failonerror attribute defines whether the operation should fail in case an error occurs, and defaults to true.

Following is the format of the <setvariable> element according to the specification of embodiment A of the present invention

<setvariable scope=“request” name=“var” failonerror=“true”>
<!-- Value specification -->
</setvariable>

Following is the format of the <removevariable> element according to the specification of embodiment A of the present invention
<removevariable scope=“request” name=“var” failonerror=“true”/>

The scope attribute is required and must be set to any one of request, session, client, user or application.

The name attribute is required and specifies the name of the variable within the specified scope.

The different value specifications can be defined using the <null>, <literal>, <getvariable>, <mapping> and <out-param-value> elements. These are explained in turn below. In a particular XSA Context, a value specification evaluates to a value, which is used as input to the <setvariable> operation.

The <null> value specification always evaluates to the null reference in the Java programming language, or its equivalent in other language bindings. This element has no content or attributes. Setting a variable to null has the same effect as if the variable was never set.

The <literal> value specification defines literal data to be used for the value. It evaluates to the text contained in the <literal> element regardless of XSA Context; components MAY convert it to a number, date or other simple types, but such typing is outside the scope of the XSA specification and implementation. An example <literal> element is as follows:
<literal> This is a literal value</literal>

The <getvariable> value specification evaluates to the value of a variable with a given name in a given scope. The scope and name are given as attributes. No content is allowed in <getvariable>. An example <getvariable> element is as follows:
<getvariable scope=“request” name=“var”/>

The scope and name attributes are required, and the scope attribute must be set to any one of request, session, client, user or application.

The <mapping> value specification is used to reference custom value specifications not defined by the XSA specification of embodiment A. It may have input parameters in the same way as XSA Components, as defined above, but not output parameters. An example <mapping> element is as follows:

<mapping refid=“mymapping”>

<in-param name=“myparam”>

<literal>literalValue</literal>

</in-param>

</mapping>

The <out-param-value> value specification can only be used as a descendant of an <out-param> element, which is used in XSA Components in pipelines and defined above. When inside the .<out-param> element, <out-param-value> contains the value of the output parameter and can be used as input to other operations, for example for storing the value of the output parameter. An example <out-param-value> element in the context of an <out-param> element is as follows:

<out-param name=“out”>

<setvariable scope=“request” name=“var”>

<out-param-value/>

</setvariable>

</out-param>

Following is a description of conditional operations as defined by the specification of embodiment A of the present invention.

Conditional operations can be used to control which XML operations are executed. They are intended to choose between different pipelines to run.

All conditions are given within the root <if> element A conditional operation is a boolean logic element which if true results in the execution of the XML operations contained within a <then>element In case the boolean element evaluates to false, an optional <else> element can contain XML Operations to execute in that case. Note that <if> is itself an XML Operation element, so conditional operations can be nested.

The format of the <if> XML Operation is as follows:

<if>

<!-- Boolean logic element, any of
and, or, not, isdefined, isoftype, equals,

condition -->

<then>

...

</then>
<else>

...

</else>

</if>

Following is a description of the various boolean logic elements defined to be used within the <if> element according to the specification of embodiment A of the present invention.

The <and> element defines the AND boolean logic operator. The content of the <and>element is one or more boolean logic elements.

The <or> element defines the OR boolean logic operator. The content of the <or> element is one or more boolean logic elements.

The <not> element defines the NOT boolean logic operator. The content of the <not> element is another boolean logic element.

The <isdefined> element contains zero or more value specifications as defined in above, and yields true if all the values are non-null, as defined by the implementation language binding. If no value specifications are included, the <isdefined> element evaluates to true.

The <isoftype> element must contain two value specifications as defined above, and yields true if the first value is of the type specified by the second value, where the meaning of “type” is defined by the implementation language binding. If either value is null, the element evaluates to false.

The <equals> element contains one or more value specifications as defined above, and evaluates to true if and only if all values are “equal”, as defined by the implementation language binding.

If all values are null, the <equals> element evaluates to true. If some are null but all, it evaluates to false. If only one value specification is specified, <equals> evaluates to true (even if the value is null).

The <condition> element is used to define custom conditions. It has the same definition as XSA components, as defined above, except no output parameters are supported. How the boolean result is evaluated depends on the implementation of the custom condition. Following is a description of error handling specification according to embodiment A of the present invention.

Error handling is twofold when using XSA according to embodiment A. First of all, there are error definitions, which can be used to define errors and what is to be done in case of the error. Second of all, errors can be raised anytime during pipeline execution.

The meaning of a named error is not specified by this specification of embodiment A, i.e. there are no predefined errors given in this specification.

Each implementation according to this specification of embodiment A is required to have a generic fall-back error mechanism, which takes care of error handling in case no match is found in the errors defined for an XSA Definition. This specification does not define how this error handling works, or what it should do in case of an error.

Errors are defined by name, and each XSA Definition may specify what to do when a certain named error is raised. Errors are defined at the root of an XSA Definition, before any XML Operations. The names used in error definitions must comply with a tree structure, where the dot (.) character separates the name on each tree level. All alphanumeric ASCII characters are allowed at each level. An example of a legal error name might be something.error.specific. This structure is used when errors are invoked, to select what error definition should be used.

The <errordef> element is used to define an error. The name attribute contains the name of the error, and the invokes attribute must give a reference to an XSA Definition to invoke in case this error is raised. The content of the <errordef> element may contain a human-readable description of the error, which will only be used for debugging, such as printing into logs. The form of the <errordef> element is as follows:
<errordef name=“some.error.name” invokes=“errorHandling.xsa”/>

Anywhere during a pipeline execution, an XPath condition can be checked. If the XPath condition evaluates to true (as defined by the XPath specification), the error definitions are searched for the closest match.

The matching mechanism tokenises the error name by dots, for example the error something.error.specific will be tokenised into something, error and specific. The error definition which includes the highest match of tokens in the same order is used. In this same example, if error definitions exist for errors something.bogus, something.error and something.error.morespecific, the XSA Definition referred to from the something.error error definition will be invoked, since something.error.morespecific is not a match.

The form of the <raiseerror> element is as follows:
<raiseerror test=“/some/xpath/to/test” error=“some.error.name”/>

The XPath given must have access to all scoped variables through XPath parameters, with the format $scope:variable-name.

An implementation is free to define its own error names, which allow an XSA Definition to handle execution errors in the XSA Engine. An example would be in case some resources are missing, which could raise an error, and the XSA Definition could define what to do in that case. The implementation must publish its error codes, and the error may not be reserved, i.e. all errors can be overridden in the XSA definition.

Implementations must also use the same XSA Context to execute an error-handling XSA Definition as was used in the XSA Definition causing the error.

Following is a description of custom operations according to the specification of embodiment A of the present invention.

The <operation> element can be used to reference custom XML operations. The only defined configuration is the parserClass attribute, which must be used to name the parser to be used to parse the content of the custom XML operation. The way in which this name maps to the parser implementation, and the programming-level interface the parser must fulfil, are specific to each XSA implementation.

The content of the <operation> element must be made available to the parser being used, and the parser can use it to define the operation. The content of the element should be put into a separate namespace from the XSA namespace to avoid potential current or future conflicts.

Following is a description of XSA execution according to the specification of embodiment A of the present invention.

The XSA Execution Engine must always execute an XSA Definition within one XSA Context. The entity that creates the XSA Context and executes the XSA, is referred to as an Adapter. An example of an Adapter is an HTTP adapter, which takes an HTTP request, selects an XSA Definition and creates its context based on information in the HTTP request and then executes the XSA Definition.

There are no rules or registration required for Adapter names—this is expected to be specific to each XSA implementation. But implementations can define adapter names so that XSA definitions can embed information about which adapters can meaningfully run the XSA. Using the <supports> element, which has one attribute, does this: adaptername. Any number of <supports> elements can appear at the beginning of an XSA definition, before any XML operations. If no <supports> element appears, then the XSA implementation must assume that any adapter can invoke the XSA.

An example <supports> list is provided shown below. This example indicates that the XSA definition may only be run in the Adapters HTTP and FTP. An Adapter named FILE must be prohibited by the XSA implementation from running this XSA.

<xsa>

<supports adaptername=“HTTP”/>
<supports adaptername=“FTP”/>
...

</xsa>

Using the detailed description of embodiment A above, someone skilled in the art could create a binding to a programming language, such as the Java programming language. Based on the detailed XSA specification defined by embodiment A of the present invention, the following is an example of a valid XML Service Action document. It does not illustrate all features of the XSA specification defined by embodiment A.

<?xml version=‘1.0’?>
<!DOCTYPE xsa

PUBLIC “-//Dimon//DTD XSA 1.1//EN”
“http://www.dimon.is/dtds/xsa/1.1/xsa.dtd”>

<xsa version=“1.1” xmlns=“http://www.dimon.is/namespaces/xsa”>

<supports adaptername=“HTTP”/>
<if>

<isdefined>

<getvariable scope=“request” name=“http.get.param”/>

</isdefined>
<then>

<pipeline>

<generator refid=“index”/>
<transformer refid=“resourcetrax”>

<in-param name=“xsl”>

<literal>index.xsl</literal>

</in-param>

</transformer>
<sink refid=“clipsersink”>

<in-param name=“outputStream”>

<getvariable scope=“request”
name=“http.responsestream”/>

</in-param>

</sink>

</pipeline>

</then>
<else>

<pipeline>

<generator refid=“alt”/>
<transformer refid=“alttrax”>

<in-param name=“xsl”>

<literal>alt.xsl</literal>

</in-param>

</transformer>
<sink refid=“clipsersink”>

<in-param name=“outputStream”>

<getvariable scope=“request”
name=“http.responsestream”/>

</in-param>

</sink>

</pipeline>

</else>

</if>

</xsa>

This concludes the description of the detailed XSA specification of a special purpose programming language as defined by embodiment A of the present invention.

While the present invention has been described as having exemplary embodiments, this patent application is intended to cover any variations, uses, or adaptations using its general principles. Further, this patent application is intended to cover such departures from the present disclosure as come within the known or customary practice within the art to which it pertains. The spirit and scope of the invention are to be limited only by the terms of the appended claims.

1. A management system for execution of tasks involving context-independent processing of structured data, the system comprising:
means for receiving a request from an external client,
a context-independent engine,
at least one adapter module for communicating between said external client and said context-independent engine, and adapting the context-independent engine to a specific application context,
at least one generator module connected to at least one back-end system residing on a computer network and is adapted to expose said at least one back-end system data as structured data ready for further processing,
at least one sink module connected to said at least one transformer for receiving said processed structured data adapted to interpreting and reacting according to the processed structured data and/or delivering the processed structured data back to said requested external client through said adapter module,
wherein the communication between the external client and the context-independent engine comprises means for selecting at least one generator module and at least one sink module for carrying out said processing of the structured data according to predefined set of instructions defined in an electronic document written in a special purpose programming language, designed for the management of processing any structured data.

2. The management system according to claim 1, wherein one or several transformer modules are connected to said at least one generator adapted to receive and transform said structured data from said at least one generator to a processed structured data.

3. The management system according to claim 1, wherein said context-independent engine reads and interprets said electronic document, written in said special purpose programming language, and controls thereby the execution within the management system.

4. The management system according to claim 1, wherein the processing of the said structured data is performed in the Extensible Mark-up Language (XML) format.

5. The management system according to claim 1, wherein said adapter module is capable of receiving and responding to requests received through Hyper Text Transfer Protocol (HTTP).

6. The management system according to claim 1, wherein the said adapter module is capable of receiving and responding to requests received through Short Message Service (SMS).

7. The management system according to claim 1, wherein the adapter module is capable of receiving and responding to requests received through Multimedia Message Service (MMS).

8. The management system according to claim 1, wherein the adapter module is capable of receiving and responding to requests received through Simple Object Access Protocol (SOAP).

9. The management system according to claim 1, wherein said transformer module is capable of transforming XML data using Extensible Stylesheet Language Transformations (XSLT).

10. The management system according to claim 1, wherein said at least one generator module is adapted to communicate with at least one of the following back-end systems and convert their native data format to XML format:
any ODBC or JDBC compliant databases,
file system on the computer in which the said management system is executing,
any data source capable of communicating using the Hyper Text Transfer Protocol (HTTP),
any data source capable of communicating using the Simple Object Access Protocol (SOAP),
Microsoft Exchange TM Personal Information Management (PIM) system,
lotus Domino TM Personal Information Management (PIM) system,
any directory service through the Light-weight Directory Access Protocol (LDAP),
any email system through Simple Mail Transfer Protocol (SMTP), Post Office Protocol (POP/POP3) or Internet Message Access Protocol (IMAP).

11. The management system according to claim 1, wherein the system is a presentation system comprising:
at least one adapter modules for receiving requests for content residing in back-end system from at least one network client,
a transformer module for transforming, in at least one step, XML source content into mark-up suitable for said at least one client, including:
transforming the XML source content to client independent mark-up,
adapting said client-independent mark-up to a version suitable for the particular type of client which requested said content,
sink module for delivering said mark-up to said clients.

12. The management system according to claim 1, wherein the format of the request from said at least one client is at least one of the following formats:
portable document format (PDF),
client-specific Hypertext Mark-up Language (HTML),
client-specific Wireless Mark-up Language (WML),
short Message Service (SMS),
Multimedia Message Service (MMS), and
compact HTML (cHTML).
xHTML

13. The management system according to claim 1, wherein the system is a messaging system comprising:
at least one adapter module adapted to communicate with external systems through a standardized electronic business protocol,
at least one generator module adapted to extract business data from source and destination system and expose it as XML,
at least one transformer module adapted to transform the relevant XML business source data into business messages,
at least one sink module adapted to delivering the business messages.

14. The management system according to claim 1, wherein the standardized business protocol is electronic business XML (ebXML).

15. The management system according to claim 1, wherein said system is an integration system comprising:
means for initiating execution of XML processing tasks without invocation from an external client,
means for synchronization of data between disparate source and destination systems wherein:
at least one generator modules extracts data from the said source system and convert it to XML source data,
at least one transformer modules transforms the XML source data into an XML format compatible with delivery into the said destination system,
at least one sink modules with means for delivering the processed XML into the destination system,
means for business process management and execution where each discrete task of a business process is defined and executed as a single XML processing task, and
means for publishing a hypertext file set on the World Wide Web with information about the status of a business process in execution.

16. The management system according to claim 1, wherein the request from the external client contains information or data, which are used by the adapter module to determine which electronic document to execute.

17. In a network with a plurality of network devices, a method for managing and executing structured-data processing tasks, comprising the following steps:
receiving a request, from an external client, for execution of a predefined context-dependant, structured-data processing task as it is defined by an instruction set wherein each of the said structured-data processing tasks is encoded in an instruction set using a special purpose, high-level programming language designed for management of processing of any structured data,
interpreting and validating the instruction set and set up context-dependant execution environment based on the said instruction set and information found in the request from said external client,
executing the context-dependant structured-data processing task, wherein the execution is comprised of the following steps:
connecting to back-end systems on the network and convert native back-end system data to structured source data, and optionally,
transforming the source structured-data into processed structured-data,
react to and/or deliver the processed structured-data back to the requesting client.

18. The method according to claim 17, wherein the processing of the said structured data is performed in the Extensible Mark-up Language (XML) format.

19. The method according to claim 17, wherein said request is received through Hyper Text Transfer Protocol (HTTP).

20. The method according to claim 17, wherein said request is received through Short Message Service (SMS).

21. The method according to claim 17, wherein said request is received through Multimedia Message Service (MMS).

22. The method according to claim 17, wherein said request is received through Simple Object Access Protocol (SOAP).

23. The method according to claim 17, wherein the XML data is transformed using Extensible Stylesheet Language Transformations (XSLT).

24. The method according to claim 17, wherein transforming the source structured-data into processed structured-data comprises transformation to XML format from formats supported by at least one of the following back-end systems:
ODBC and/or JDBC compliant databases,
file system on the computer in which the said management system is executing,
any data source capable of communication through the Hyper Text Transfer Protocol (HTTP),
any data source capable of communication through the Simple Object Access Protocol (SOAP),
Microsoft Exchange TM Personal information management (PIM) system,
Lotus Domino TM Personal information management (PIM) system,
any directory service through the Light-weight Directory Access Protocol (LDAP),
any email system through Simple Mail Transfer Protocol (SMTP), Post Office Protocol (POP/POP3) or Internet Message Access Protocol (IMAP).

25. A computer readable medium having stored therein instructions for causing a central processing unit to execute the method of claim 17.
